(19) United States
(12) Patent Application Publication
(10) Pub. No.: US 2021/0299756 A1
(43) Pub. Date: Sep. 30, 2021

(54) CUTTING APPARATUS AND CUTTING METHOD

(71) Applicant: National University Corporation Tokai National Higher Education and Research System, Nagoya-shi (JP)

(72) Inventors: Eiji SHAMOTO, Nagoya-shi (JP); Hongjin CHUNG, Nagoya-shi (JP); Takehiro HAYASAKA, Nagoya-shi (JP)

(21) Appl. No.: 17/184,106

(22) Filed: Feb. 24, 2021

Related U.S. Application Data
(63) Continuation of application No. PCT/JP2020/014711, filed on Mar. 30, 2020.

(51) Int. Cl. B23B 13/08; B23B 7/12

(52) U.S. Cl. CPC B23B 13/08; B23B 2270/48; B23B 2250/16; B23B 7/12

(57) ABSTRACT

A cutting apparatus includes a cutting tool having a cutting edge, an excitation part structured to apply excitation to the cutting tool, and a drive part structured to apply a voltage to the excitation part to reciprocate the cutting edge of the cutting tool. The excitation part suppresses residual oscillations by applying excitation that contains an excitation force of components of frequencies higher than a resonance frequency and has an excitation force of the resonance frequency suppressed. The excitation part applies a first excitation, and applies a second excitation after an elapse of a time 0.5 times as long as a resonance period from timing at which the first excitation is applied to suppress residual resonance oscillations.

### CROSS-REFERENCE TO RELATED APPLICATIONS

This application is based upon and claims the benefit of priority from the International Application No. PCT/JP2020/014711, filed on Mar. 30, 2020, the entire contents of which are incorporated herein by reference.

### BACKGROUND

### 1. Field of the Disclosure

The present disclosure relates to a technique for cutting a surface of a workpiece by exciting a cutting tool to displace a cutting edge.

### 2. Description of the Related Art

Microtexturing is a technique for controlling mechanical properties of a machined surface by forming a fine periodic structure, and applied research in various fields has been conducted on microtexturing.

For example, it is known that forming a microtexture serving as an oil pool on a sliding surface to which lubricating oil is applied allows reductions in friction coefficient and wear, and allows high lubrication with a small amount of lubricating oil that is low in viscosity.

Possible approaches to forming a microtexture through machining process include a method for forming the machined surface by reciprocating a cutting edge of a cutting tool relative to a workpiece while relatively moving an oscillator to which the cutting tool is attached and the workpiece. At this time, the use of a mechanical resonance phenomenon allows a cutting depth of micron order with high efficiency, but the oscillator oscillates in a sine waveform; therefore, the shape of the obtained machined surface is limited to a periodic shape that depends on the sine wave path of the tool cutting edge.

JP 2018-187726 A discloses a cutting apparatus that excites an oscillating device in a plurality of resonance modes to give various oscillation paths to the tool cutting edge. An ultrasonic oscillating device disclosed in JP 2018-187726 A combines an oscillation mode having a fundamental frequency with an oscillation mode having a resonance frequency that is an integral multiple of fundamental frequency, and applies excitation in both oscillation modes at the same time to transfer, to the machined surface, an oscillation path that result from superposing sine waves of a plurality of resonance frequencies.

The cutting apparatus disclosed in JP 2018-187726 A allows large oscillation displacement (that is, cutting fluctuation) at a high frequency by utilizing a large amplitude magnification factor at the resonance frequency and thus allows micromachining with high efficiency, but the oscillation path is limited to a shape that results from superposing a plurality of sine waves.

On the other hand, a machining technique called Fast tool servo (FTS) that moves the tool cutting edge with a waveform composed of components in a frequency band lower than the resonance frequency without utilizing the resonance phenomenon is available. FTS can give, to the cutting edge, not only such a sinusoidal oscillation path but also a complicated oscillation path, so that FTS is suitable for forming various fine shapes other than periodic shapes on the surface of the workpiece; however, FTS uses only a frequency band lower than the resonance frequency, thereby making it unable to perform machining with high efficiency.

### SUMMARY

The present disclosure has been made in view of such circumstances, and it is therefore an object of the present disclosure to provide a machining technique that allows machining with high efficiency and allows various oscillation paths to be given to a tool cutting edge.

In order to solve the above-described problems, a cutting apparatus according to one aspect of the present disclosure includes a cutting tool having a cutting edge, an excitation part structured to apply excitation to the cutting tool, and a drive part structured to apply a voltage to the excitation part to reciprocate the cutting edge of the cutting tool. The excitation part suppresses residual oscillations by applying excitation that contains an excitation force of components of frequencies higher than a resonance frequency and has an excitation force of the resonance frequency suppressed.

Another aspect of the present disclosure is a cutting method. This method is a cutting method for applying excitation to a cutting tool having a resonance frequency to cause a cutting edge of the cutting tool to cut into a workpiece, the cutting method including suppressing residual oscillations by applying excitation that contains an excitation force of components of frequencies higher than the resonance frequency and has an excitation force of the resonance frequency suppressed.

Note that any combination of the above-described components, or an entity that results from replacing expressions of the present disclosure among a method, an apparatus, a system, a recording medium, computer program, and the like is also valid as an aspect of the present disclosure.

### BRIEF DESCRIPTION OF THE DRAWINGS

FIG. 1 is a diagram showing a schematic structure of a cutting apparatus according to an embodiment;

FIG. 2 is a diagram showing an example of a structure of an oscillating device;

FIGS. 3A and 3B are diagrams for describing the principle of Input Shaping control;

FIG. 4 is a diagram showing a compliance transfer function of a single degree-of-freedom oscillating system;

FIG. 5 is a diagram showing an impulse response of the single degree-of-freedom oscillating system;

FIG. 6A is a diagram showing an example of an input waveform of a first excitation and a second excitation, and

FIG. 6B is a diagram showing response displacement of an oscillating system;

FIG. 7A is a diagram showing a result of Fourier transform of the excitation force waveform shown in FIG. 6A, and FIG. 7B is a diagram showing a result of Fourier transform of the response displacement shown in FIG. 6B;

FIG. 8A is a diagram showing an example of the input waveform of the first excitation and the second excitation, and FIG. 8B is a diagram showing response displacement of the oscillating system;

FIG. 9A is a diagram showing an example of the input waveform of the first excitation and the second excitation, and FIG. 9B is a diagram showing response displacement of the oscillating system;

FIG. 10A is a diagram showing an example of the input waveform of the first excitation and the second excitation, and FIG. 10B is a diagram showing response displacement of the oscillating system;

FIG. 11 is a diagram showing a compliance transfer function of a three degree-of-freedom oscillating system;

FIG. 12 is a diagram showing an impulse response of the three degree-of-freedom oscillating system;

FIG. 13A is a diagram showing an example of an input waveform of eight impulse excitations, and FIG. 13B is a diagram showing response displacement of the oscillating system;

FIG. 14A is a diagram showing a result of Fourier transform of the excitation force waveform shown in FIG. 13A, and FIG. 14B is a diagram showing a result of Fourier transform of the response displacement shown in FIG. 13B;

FIGS. 15A and 15B are diagrams showing examples of the excitation force waveform, and FIG. 15C is a diagram showing response displacement of the oscillating system; and

FIG. 16 is a diagram showing functional blocks of the cutting apparatus.

### DETAILED DESCRIPTION

The disclosure will now be described by reference to the preferred embodiments. This does not intend to limit the scope of the present disclosure, but to exemplify the disclosure.

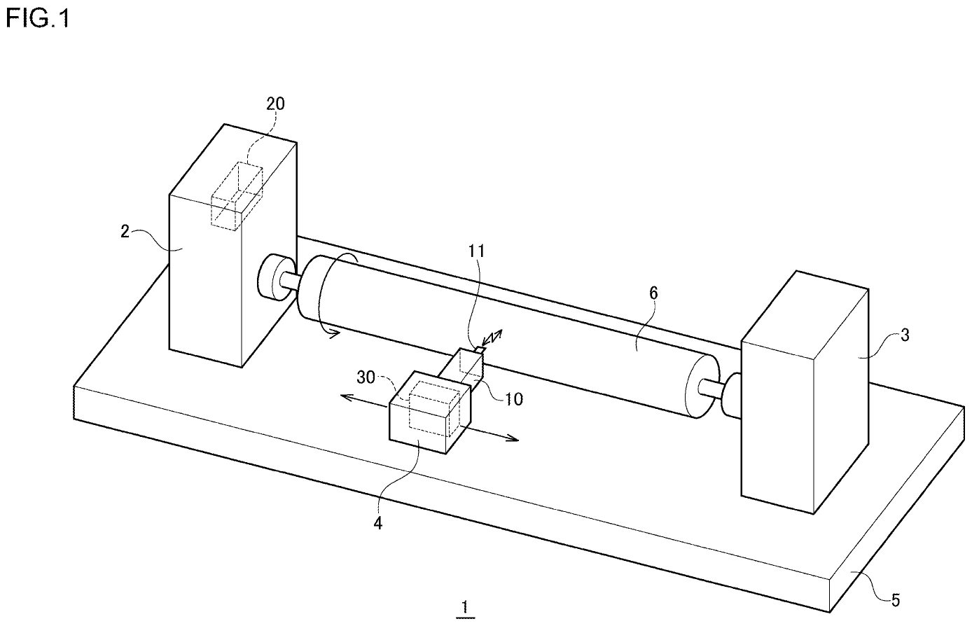

FIG. 1 shows a schematic structure of a cutting apparatus 1 according to an embodiment. The cutting apparatus 1 is a machining apparatus that performs machining process of a turning type on a workpiece 6 by reciprocating a cutting edge of a cutting tool 11. The cutting apparatus 1 according to the embodiment is a roll lathe that turns the workpiece 6 having a cylindrical shape to form a rolling roll, but may be a cutting apparatus of any other type. The workpiece 6 is typically a die steel having a surface plated with nickel phosphorus, a copper material, an aluminum material, or the like, but may be another material.

The cutting apparatus 1 includes, on a bed 5, a headstock 2 and a tailstock 3 that support the workpiece 6 rotatable, and a tool post 4 that supports an oscillating device 10 to which the cutting tool 11 is attached. Further, the cutting apparatus 1 includes a feed mechanism that moves at least the tailstock 3 relative to the headstock 2, and a feed mechanism that moves the tool post 4 in a feed direction parallel to an axial direction of the workpiece 6 and in a depth-of-cut direction orthogonal to the axial direction (a direction in which the cutting tool 11 is brought closer to a rotation axis of the workpiece 6). During cutting process, the workpiece 6 is rotated by a spindle provided on the headstock 2.

A drive part 30 is a driver that applies a voltage to the oscillating device 10 to displace the cutting tool 11 to reciprocate the cutting edge of the cutting tool 11 relative to the workpiece 6. A controller 20 supplies an applied voltage regulation command to the drive part 30 to regulate the voltage supplied to the oscillating device 10 by the drive part 30. Note that, in an example of a structure shown in FIG. 1, the controller 20 is provided inside the headstock 2, but may be provided in a space other than the inside of the headstock 2. The controller 20 may regulate the voltage supplied by the drive part 30 in cooperation with an NC control device (not shown) that controls operation of the spindle and operation of each feed mechanism. Further, the controller 20 may have the NC control device built therein, and may control the operation of the spindle and the operation of each feed mechanism and regulate the voltage supplied by the drive part 30.

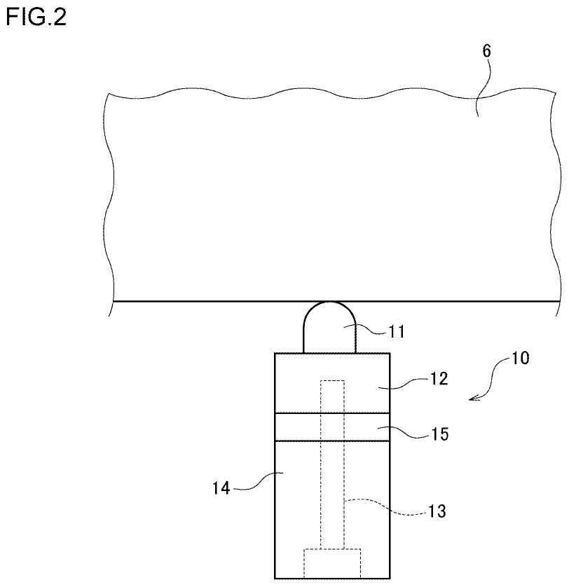

FIG. 2 shows an example of a structure of the oscillating device 10. The oscillating device 10 includes a tool attachment part 12 to which the cutting tool 11 having the cutting edge is attached, a shank 14, and an excitation part 15 provided between the tool attachment part 12 and the shank 14. The tool attachment part 12, the excitation part 15, and the shank 14 are coupled by a coupling structure using a bolt 13.

The excitation part 15 is driven by the drive part 30 to apply excitation to the tool attachment part 12 and the cutting tool 11. The excitation part 15 may be an actuator such as a piezoelectric element. The drive part 30 applies a voltage to the excitation part 15 to displace the tool attachment part 12 to reciprocate the cutting edge of the cutting tool 11 relative to the workpiece 6.

When the drive part 30 applies the voltage to the excitation part 15, the excitation part 15 extends in response to the applied voltage to apply an excitation force to the tool attachment part 12 and the cutting tool 11. When the tool attachment part 12 is pushed in the depth-of-cut direction by the extended excitation part 15, the coupling structure fastened by the bolt 13 prevents the cutting tool 11 from being inclined and causes the cutting edge whose orientation is maintained to cut into the workpiece 6. Further, when the tool attachment part 12 is retracted in the depth-of-cut direction by the excitation part 15, the coupling structure fastened by the bolt 13 plays a role of applying a high preload toward the compression side between the excitation part 15 and the tool attachment part 12 and between the excitation part 15 and the shank 14 so as to prevent the excitation part 15 from separating from the tool attachment part 12 and the shank 14. In other words, this preload allows oscillation characteristics of the oscillating device 10 to maintain linearity up to a high frequency band.

A description will be given below of a method for forming a fine shape on the surface of the workpiece 6 according to the embodiment. The method according to the embodiment allows high responsiveness by positively causing the excitation force applied by the excitation part 15 to contain components of frequencies higher than the resonance frequency. On the other hand, for the purpose of giving any desired oscillation path to the cutting edge, the excitation force of the resonance frequency is suppressed so as to substantially prevent the occurrence of residual resonance oscillations, that is, to suppress the occurrence of the residual resonance oscillations. Suppressing the excitation force of the resonance frequency to substantially prevent the occurrence of residual oscillations allows an aperiodic cutting edge oscillation path.

Note that when the excitation force of components of frequencies higher than the resonance frequency is used, an amplitude magnification factor and phase greatly change; therefore, the excitation force waveform applied to the cutting tool 11 by the excitation part 15 and the oscillation path (output waveform) of the cutting edge of the cutting tool 11 are totally different from each other. When oscillation characteristics of the oscillating system are measured in advance so as to be known, a relationship between the input and output is made predictable, and when it is possible to measure or estimate the output oscillation path, it is also possible to correct the excitation force waveform so as to obtain the desired oscillation path.

A description will be given below of an excitation force waveform applied to the cutting tool 11 by the excitation part 15 in order to generate various oscillation paths of the cutting edge of the cutting tool 11. As described above, with the machining technique according to the embodiment, the excitation force of the component of the resonance frequency is suppressed so as to substantially prevent the occurrence of the residual resonance oscillations, but a description will be given below of a technique for suppressing the occurrence of the excitation force of the resonance frequency by using Input Shaping control.

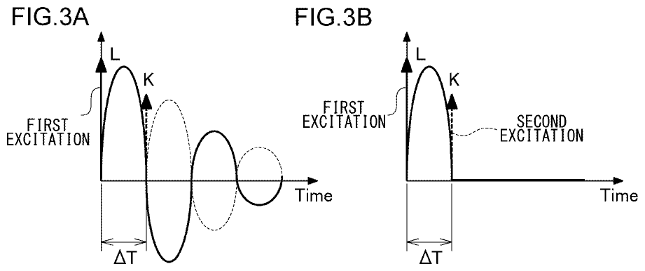

FIGS. 3A and 3B are diagrams for describing the principle of Input Shaping control. FIG. 3A shows response oscillations when a first impulse excitation (first excitation) of magnitude L is applied. FIG. 3B shows response oscillations when a second impulse excitation (second excitation) of magnitude K is applied after an elapse of ΔT.

Under the Input Shaping control according to the embodiment, a half wave of the resonance frequency (a wave in a range of 0 to 180 degrees of a sine wave of the resonance period) is generated from two impulse excitations. A time interval ΔT between the two impulse excitations is 0.5 times as long as the resonance period with damping taken into consideration, and oscillations generated by the first excitation are canceled by the second excitation. Note that it is known that an oscillation amplitude A(t) decreases by e^{-ζωn ΔT} times during ΔT due to damping, as represented by Equation (1).

A(t+ΔT)=e^{-ζ}^{ₙ}^{ΔT}A(t) (1)

where ζ represents a damping ratio, ωₙ represents a resonance angular frequency, and ΔT is ΔT=π/(ωₙ √(1−ζ²)). On the basis of this relationship, the amplitude after an elapse of ΔT is estimated, and magnitude K (time integral value of the impulse waveform) of the second impulse excitation is set against magnitude L of the first impulse excitation in accordance with an amplitude damping factor so as to completely eliminate residual oscillations.

The half-wave displacement thus obtained can be used to form an aperiodic shape on a machined surface. For example, weighting the half-wave displacement as desired and then superposing the weighted half-wave displacements slightly shifted in time from each other allows pulse-like displacements of various shapes to be generated.

A description will be given below of specific examples of the excitation force waveform applied to the cutting tool 11 by the excitation part 15 and the oscillation path output to the cutting edge of the cutting tool 11 according to the embodiment. As simulation conditions, assuming that a single degree-of-freedom oscillating system has mass m=0.01 kg, spring constant k=150 N/μm, and damping ratio ζ=0.015. In the oscillating device 10 shown in FIG. 2, the oscillating system includes the cutting tool 11 and the tool attachment part 12 to which excitation is applied by the excitation part 15.

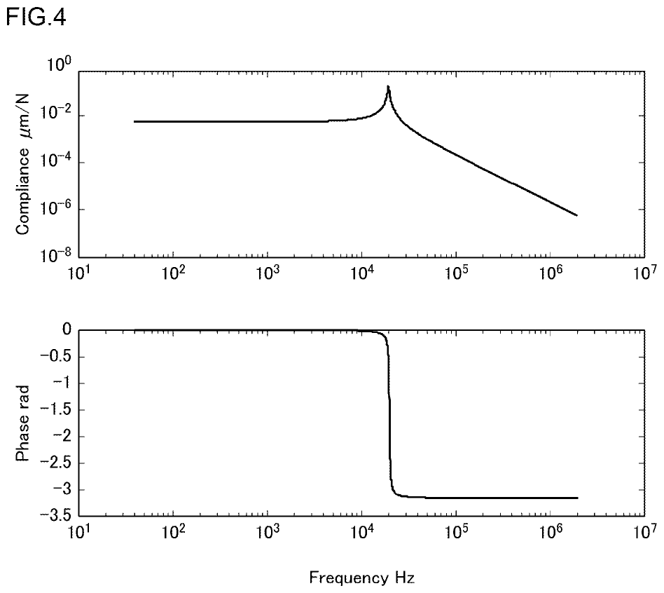

FIG. 4 shows a compliance transfer function G of the assumed single degree-of-freedom oscillating system. An impulse response g of this oscillating system is obtained by inverse Fourier transform of the compliance transfer function G.

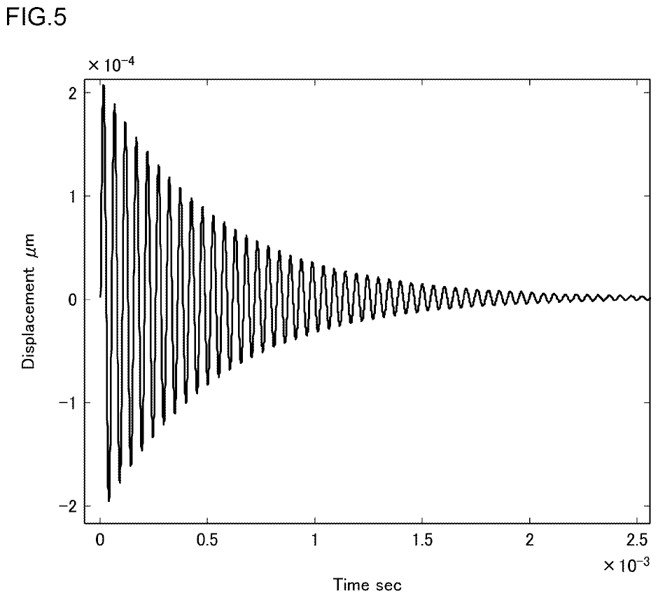

FIG. 5 shows the impulse response g of the assumed single degree-of-freedom oscillating system. As shown in FIG. 3B, after an elapse of time ΔT (a time 0.5 times as long as the resonance period) from time 0, the impulse excitation (second excitation) with the amplitude damping factor taken into consideration is applied against the impulse excitation (first excitation) of this single degree-of-freedom oscillating system, so that residual oscillations can be eliminated.

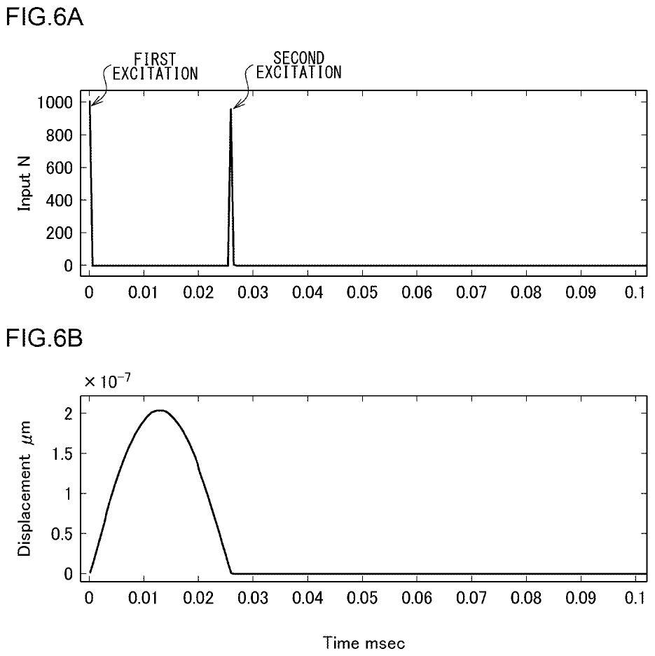

FIG. 6A shows an example of the input waveform of the first excitation and the second excitation, and FIG. 6B shows response displacement of the oscillating system. The response displacement shown in FIG. 6B corresponds to the oscillation path of the cutting edge of the cutting tool 11. The application of the second excitation eliminates residual oscillations caused by the first excitation and allows response displacement having a time width corresponding to the half wave to be obtained.

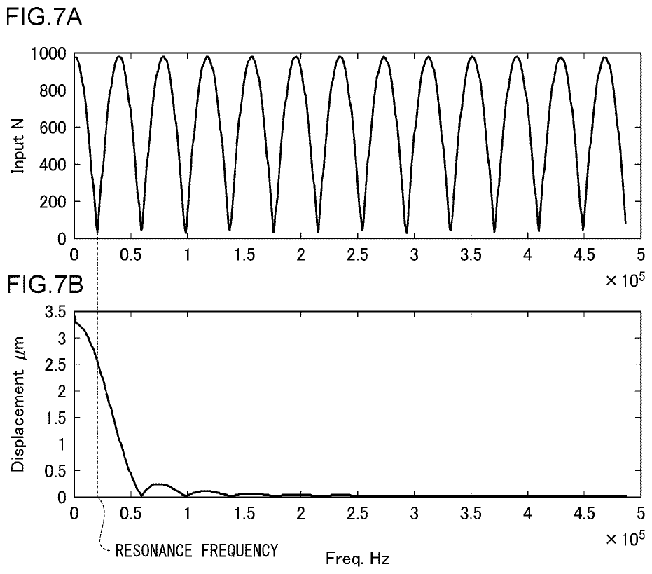

FIG. 7A shows a result of Fourier transform (frequency analysis) of the excitation force waveform shown in FIG. 6A. As shown in FIG. 7A, the excitation force applied to the oscillating system contains almost no component of the resonance frequency and odd multiples of the component, and therefore the occurrence of resonance-dependent residual oscillations is suppressed. On the other hand, the other components in a high-frequency range higher than the resonance frequency contains large excitation forces; therefore, applying excitation to the cutting tool 11 with the excitation force waveform shown in FIG. 6A allows high-speed displacement having a short time width to be obtained.

Known micromachining does not substantially utilize the excitation force in a frequency range higher than the resonance frequency, but the technique according to the embodiment allows high responsiveness by positively causing the excitation force applied by the excitation part 15 to contain components of frequencies higher than the resonance frequency. When an integral value of the excitation force in the frequency range lower than the resonance frequency is denoted by I_low, and an integral value of the excitation force in the frequency range higher than the resonance frequency is denoted by I_high, a ratio of I_high to I_low (I_high/I_low) according to the embodiment is preferably equal to or greater than 1/100, more preferably equal to or greater than 1/10, and further preferably equal to or greater than 1. The larger (I_high/I_low), the larger the excitation force in the high frequency range, thereby allowing more efficient machining. Note that in FIG. 7A, I_low corresponds to an area of the excitation force waveform lower than the resonance frequency, and I_high corresponds to an area of the excitation force waveform higher than the resonance frequency.

FIG. 7B shows a result of Fourier transform of the response displacement shown in FIG. 6B. FIG. 7B shows that the obtained response displacement contains the component of the resonance frequency and a large amount of components of frequencies higher than the resonance frequency, and a displacement response faster than the resonance frequency can be achieved.

According to the above-described simulation, the oscillating device 10 according to the embodiment can reciprocate the cutting tool 11 with high efficiency by the response displacement having the half-wave shape shown in FIG. 6B. This allows the oscillating device 10 to form a half-wave-shaped minute dent on the machined surface at any desired timing when cutting the workpiece 6. As described above, according to the embodiment, the excitation part 15 applies excitation that contains the excitation force of components of frequencies higher than the resonance frequency and has the excitation force of the resonance frequency suppressed so as to prevent the occurrence of residual oscillations, so that an aperiodic concave shape or convex shape can be formed on the machined surface.

Note that the response displacement generated according to the embodiment is applicable to the following micromachining.

(1) The surface of the workpiece is micromachined to form concave portions by displacing, in the depth-of-cut direction, the cutting tool 11 that has not cut into the workpiece 6, that is, the cutting tool 11 that is separated from the workpiece.

(2) The surface of the workpiece is micromachined to form concave portions by further displacing, in the depth-of-cut direction, the cutting tool 11 that has cut into the workpiece while performing milling process on the surface of the workpiece.

(3) The surface of the workpiece is micromachined to form convex portions by displacing, in the retracting direction, the cutting tool 11 that has cut into the workpiece while performing milling process on the surface of the workpiece.

An example of generating response displacement different from the displacement of a half-wave of a sine wave in the assumed single degree-of-freedom oscillating system will be shown below. In the field of tribology, it is desirable that a texture shape created on a slide guide surface serves as an oil pool and also generates hydrodynamic pressure, but it is required for the generation of hydrodynamic pressure that connection portions (boundaries) between a curve of a concave portion and a flat portion of the machined surface be smoothly connected.

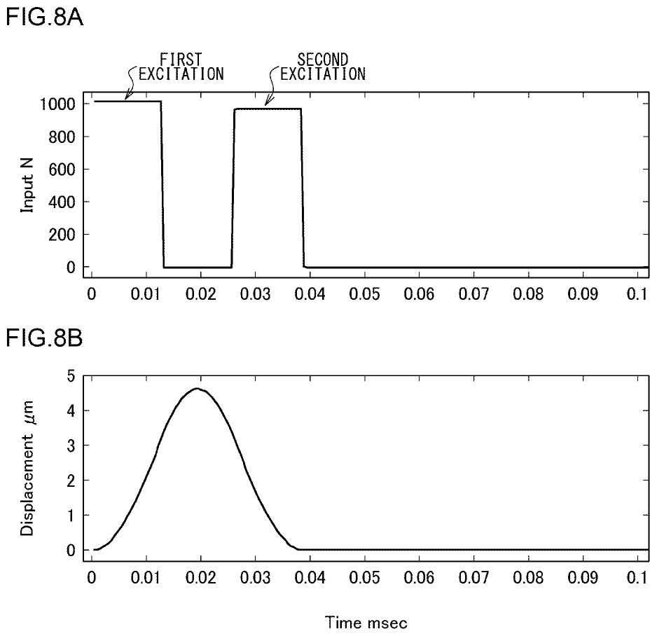

FIG. 8A shows an example of the input waveform of the first excitation and the second excitation, and FIG. 8B shows response displacement of the oscillating system. Similar to the input waveform shown in FIG. 6A, in the input waveform shown in FIG. 8A, the second excitation is applied after an elapse of a time 0.5 times as long as the resonance period from the timing of the first excitation to suppress the occurrence of residual resonance oscillations. In this example, the first excitation is applied with an input waveform of a square wave having a time width 0.25 times as long as the resonance period, and the second excitation is applied with an input waveform of a square wave having the same time width with a delay of a time 0.5 times as long as the resonance period.

The application of the second excitation with a delay of a time 0.5 times as long as the resonance period from the timing at which the first excitation is applied cancels out the excitation force of the component of the resonance frequency. Note that, as shown in FIG. 8A, with the damping of the oscillating system taken into consideration, the excitation force of the second excitation is set lower than the excitation force of the first excitation in accordance with the damping ratio represented by Equation (1), so that residual oscillations can be totally eliminated and the response displacement can be made zero as shown in FIG. 8B.

Making both the time widths of the first excitation and the second excitation large allows an increase in response displacement as compared with the response displacement shown in FIG. 6B, and, in this example, peak displacement of micron order (about 4.6 μm) can be obtained. Further, the rising edge of the response displacement waveform (0 msec) has a shape that gradually increases so as to smoothly connect to the flat portion of the machined surface, and the falling edge of the response displacement waveform (about 0.0385 msec) has a shape that gradually decreases so as to smoothly connect to the flat portion of the machined surface.

According to the above-described simulation, the oscillating device 10 according to the embodiment can form, on the machined surface, a texture shape that serves as an oil pool and also generates hydrodynamic pressure by reciprocating the cutting tool 11 at any desired timing in accordance with the response displacement having the shape shown in FIG. 8B. As described above, according to the embodiment, the excitation part 15 applies excitation that contains the excitation force of components of frequencies higher than the resonance frequency and has the excitation force of the resonance frequency suppressed so as to prevent the occurrence of residual oscillations, so that an aperiodic concave shape can be formed on the machined surface.

An example of the response displacement generated when the time width of the excitation force waveform is further increased (herein, 1.5 times as long as the resonance period) will be given below.

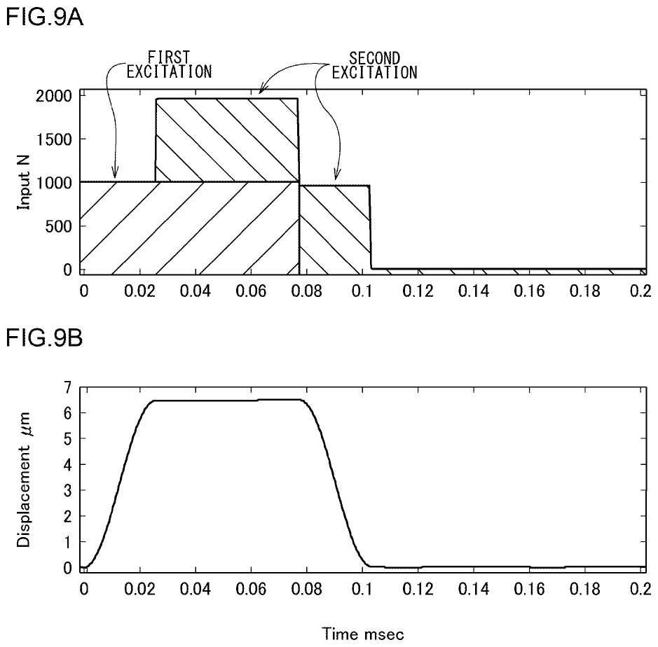

FIG. 9A shows an example of the input waveform of the first excitation and the second excitation, and FIG. 9B shows response displacement of the oscillating system. Similar to the input waveform shown in FIG. 6A, in the input waveform shown in FIG. 9A, the second excitation is applied after an elapse of a time 0.5 times as long as the resonance period from the timing at which the first excitation is applied to suppress the occurrence of residual resonance oscillations. Specifically, the input waveform of the second excitation lags behind the input waveform of the first excitation by a time 0.5 times as long as the resonance period. In this example, the first excitation is applied with an input waveform of a square wave that has a time width 1.5 times as long as the resonance period and is hatched with diagonal lines from the upper right, and the second excitation is applied with an input waveform of a square wave that has a time width 1.5 times as long as the resonance period and is hatched with diagonal lines from the upper left with a delay of a time 0.5 times as long as the resonance period. As compared with the excitation force waveform shown in FIG. 8A, making the time width of each square wave longer than 0.5 times the resonance period forms a response waveform in which the excitation force waveform of the first excitation and the excitation force waveform of the second excitation overlap, and the peak value of response displacement is maintained constant (in a range from about 0.0257 msec to about 0.0770 msec in FIG. 9B).

Proposed below is an excitation force waveform that generates response displacement that rises/falls more smoothly (more gradually) than the response displacement shown in FIG. 8B.

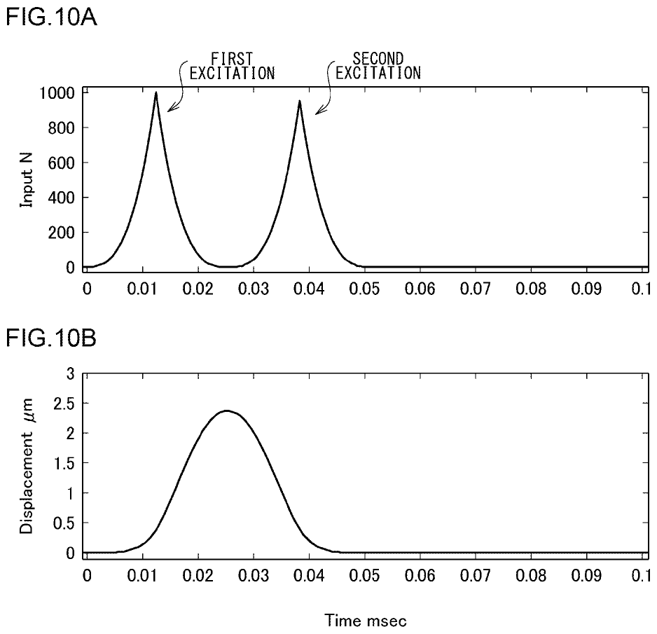

FIG. 10A shows an example of the input waveform of the first excitation and the second excitation, and FIG. 10B shows response displacement of the oscillating system. Similar to the input waveform shown in FIG. 6A, in the input waveform shown in FIG. 10A, the second excitation is applied after an elapse of a time 0.5 times as long as the resonance period from the timing at which the first excitation is applied to suppress the occurrence of residual resonance oscillations. Specifically, the input waveform of the second excitation lags behind the input waveform of the first excitation by a time 0.5 times as long as the resonance period.

For the first excitation and the second excitation shown in FIG. 10A, an input waveform is adopted in which the excitation force gradually rises and then gradually falls in accordance with a cubic function. In this example, the excitation force rises in accordance with a cubic function with a time width 0.25 times as long as the resonance period (the excitation force increases with the passage of time to be proportional to the cube of the time), and then the excitation force falls with the same time width in line symmetry. This sharp protruding excitation force waveform is damped and then applied again with a delay of a time 0.5 times as long as the resonance period to the oscillating system, so that residual oscillations can be eliminated. As a result, as shown in FIG. 10B, response displacement with a gradual rise and fall is obtained.

The excitation force waveform of the single degree-of-freedom oscillating system has been described above, but a description will be given below of an excitation force waveform of a three degree-of-freedom oscillating system having three oscillation modes. As simulation conditions, assuming that parameters of the three oscillation modes include mass m=0.01 kg, 0.3 kg, 0.02 kg, spring constant k=150 N/μm, 1000 N/μm, 1800 N/μm, damping ratio (=0.015, 0.02, 0.008 and that a compliance transfer function G can be obtained by superposing compliance transfer functions of these three oscillation modes.

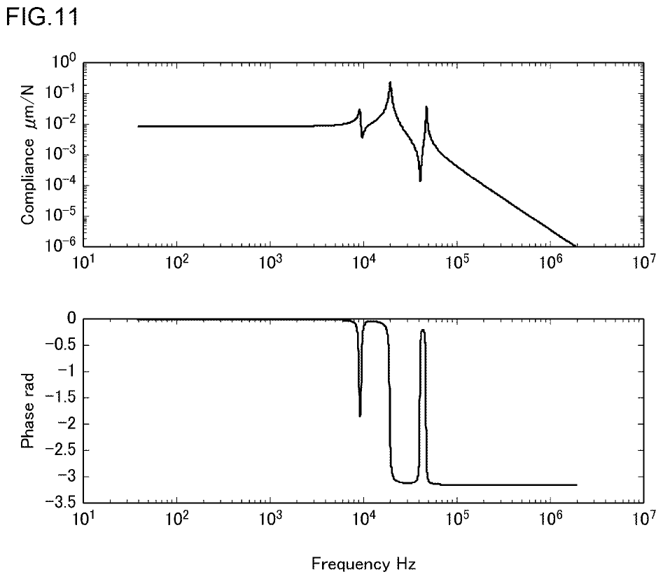

FIG. 11 shows the compliance transfer function G of the assumed three degree-of-freedom oscillating system. An impulse response g of this oscillating system is obtained by inverse Fourier transform of the compliance transfer function G.

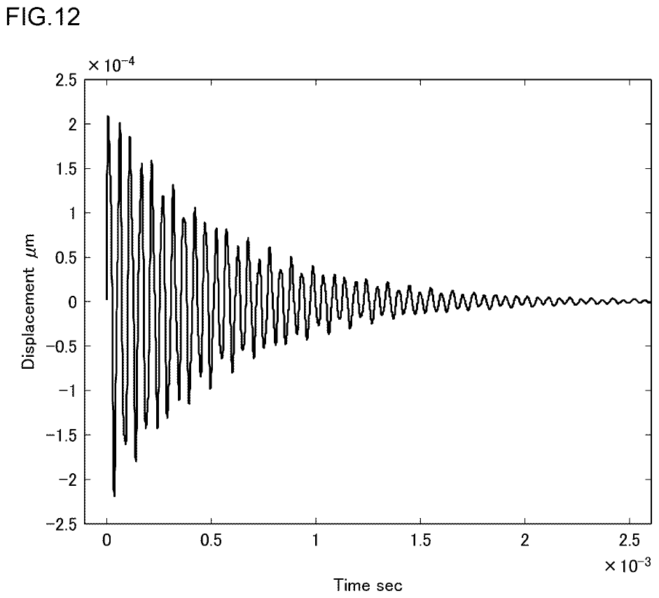

FIG. 12 shows an impulse response g of the assumed three degree-of-freedom oscillating system.

In order to eliminate residual oscillations when impulse excitation is applied to the three degree-of-freedom oscillating system, it is necessary to apply Input Shaping control to each oscillation mode. That is, one impulse excitation is applied to cancel residual oscillations of the first oscillation mode, two impulse excitations are applied to cancel residual oscillations of the second oscillation mode that respond to the two impulse excitations, and four impulse excitations are applied to cancel residual oscillations of the third oscillation mode that respond to the four impulse excitations. As described above, in the oscillating system having three oscillation modes, applying a total of seven impulse excitations against one impulse excitation allows short-time response displacement with no residual oscillation to be generated.

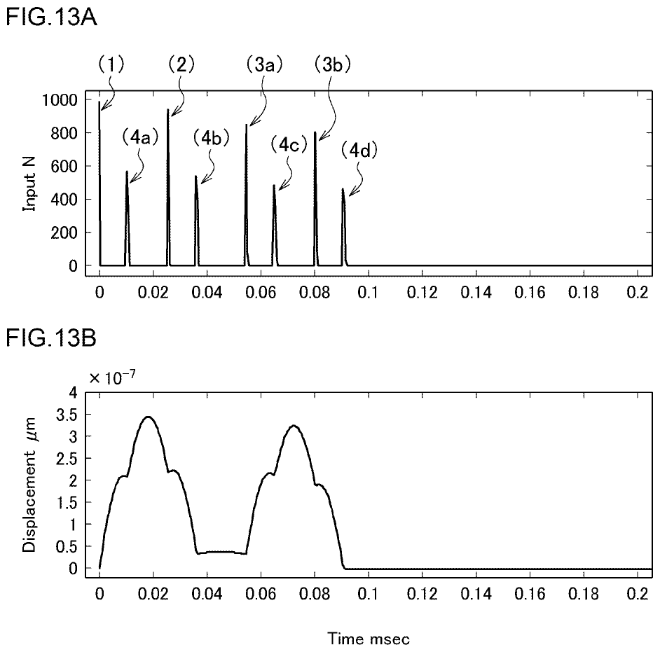

FIG. 13A shows an example of an input waveform of eight impulse excitations. Impulse excitation (2) is applied to cancel residual oscillations of the first oscillation mode (19.5 kHz) caused by impulse excitation (1). Impulse excitations (3a), (3b) are applied to cancel residual oscillations of the second oscillation mode (9.2 kHz) caused by impulse excitations (1), (2). Impulse excitations (4a), (4b), (4c), (4d) are applied to cancel residual oscillations of the third oscillation mode (47.7 kHz) caused by impulse excitations (1), (2), (3a), (3b). Note that the reason why the peak value of the impulse excitation applied to cancel residual oscillations is reduced by the damping ratio of the oscillation amplitude or more compared to the peak value of the previous impulse excitation is that the cycle time Δt in this case is 0.513 μsec that is not sufficiently smaller than ΔT that is a half of the resonance period, impulse excitation for suppressing residual oscillations cannot be applied just after ΔT, and thus impulse excitation for suppressing residual oscillations is applied twice before and after ΔT. FIG. 13B shows response displacement of the oscillating system.

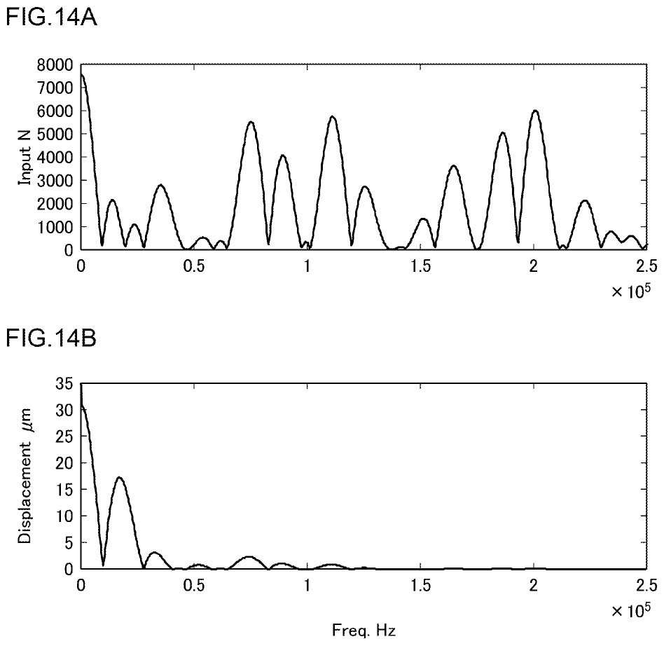

FIG. 14A shows a result of Fourier transform of the excitation force waveform shown in FIG. 13A. As shown in FIG. 14A, the excitation force applied to the oscillating system contains almost no components of three resonance frequencies (19.5, 9.2, 47.7 kHz) and odd multiples of the components, and therefore the occurrence of resonance-dependent residual oscillations is suppressed. On the other hand, the other components in a high-frequency range higher than the resonance frequencies contain large excitation forces; therefore, applying excitation to the cutting tool 11 with the excitation force waveform shown in FIG. 13A allows high-speed displacement having a short time width to be obtained.

FIG. 14B shows a result of Fourier transform of the displacement shown in FIG. 13B. As shown in FIG. 7B, it is shown that the obtained response displacement contains the components of the resonance frequencies and a large amount of components of frequencies higher than the resonance frequency, and a displacement response faster than the resonance frequency can be achieved.

An excitation force waveform that generates response displacement that smoothly rises/falls in the assumed three degree-of-freedom oscillating system will be shown below.

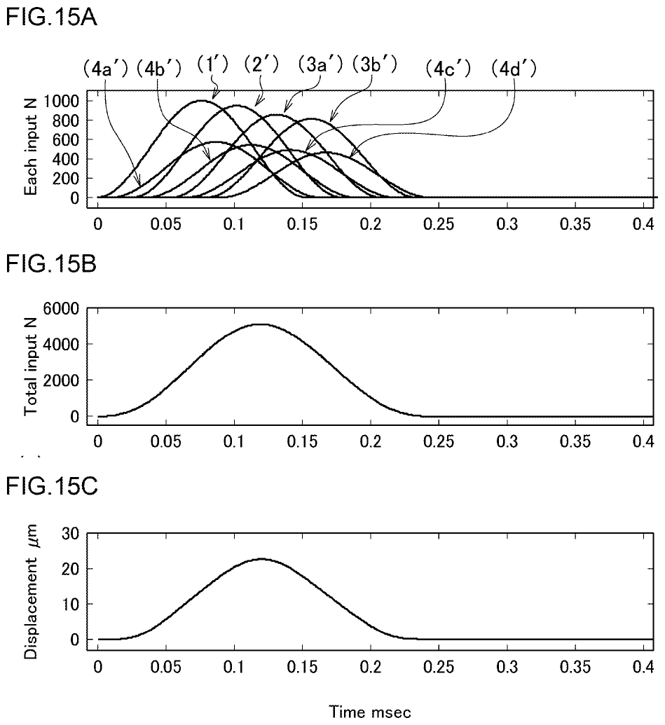

FIG. 15A shows examples of input waveforms of eight excitations. Herein, each excitation force waveform is set to gradually rise/fall in the form of a cosine wave (in a phase range of −180 degrees to 180 degrees). Excitation force waveform (2′) is applied to cancel residual oscillations of the first oscillation mode (19.5 kHz) caused by excitation force waveform (1′). Excitation force waveforms (3a′), (3b′) are applied to cancel residual oscillations of the second oscillation mode (9.2 kHz) caused by excitation force waveforms (1′), (2′). Excitation force waveforms (4a′), (4b′), (4c′), (4d′) are applied to cancel residual oscillations of the third oscillation mode (47.7 kHz) caused by excitation force waveforms (1′), (2′), (3a′), (3b′).

FIG. 15B shows a waveform resulting from superposing the eight excitation force waveforms shown in FIG. 15A. Specifically, the waveform shown in FIG. 15B is the same as a waveform input to the oscillating system.

FIG. 15C shows response displacement of the oscillating system. As shown in FIG. 15C, residual oscillations are eliminated, and the displacement waveform having a gentle rise and fall connecting flat portions is obtained.

As described above, according to the embodiment, the oscillating device 10 can apply displacements of various shapes to the cutting edge of the cutting tool 11 in a short time width so as to prevent the occurrence of residual oscillations. These displacements may be repeated at any desired timing (after an elapse of any desired time), and the shape and magnitude of the displacements may be changed. According to the embodiment, the excitation force waveform that forms the flat portions by eliminating residual oscillations has been described, but it is also possible to generate another displacement waveform immediately after the generation of a certain displacement waveform. As described above, the oscillating device 10 can generate minute displacement waveforms of various shapes at high speed (in a short time width) so as to prevent the occurrence of residual oscillations, so that highly efficient machining of various fine shapes becomes possible.

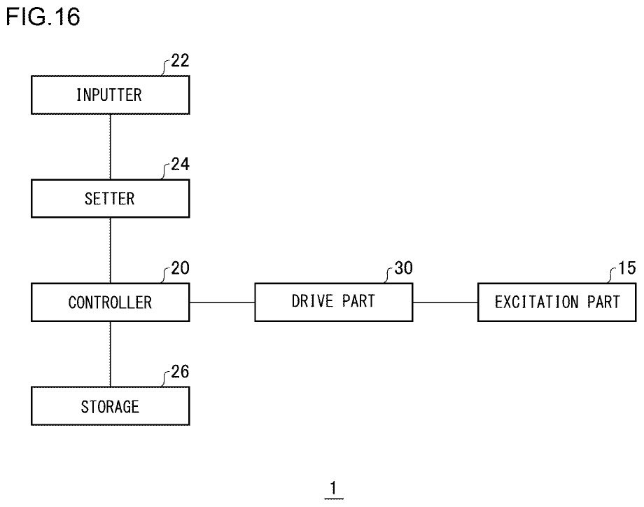

FIG. 16 shows functional blocks of the cutting apparatus 1. The cutting apparatus 1 includes an inputter 22, a setter 24, the controller 20, a storage 26, the drive part 30, and the excitation part 15. The storage 26 stores voltage waveforms corresponding to a plurality of excitation force waveforms for use in forming a plurality of machining shapes. Herein, the voltage waveforms corresponding to the excitation force waveforms are voltage waveforms to be applied to the excitation part 15 so as to cause the excitation part 15 to apply excitation to the cutting tool 11 with a corresponding one of the excitation force waveforms. The storage 26 may store voltage waveforms corresponding to the excitation force waveform shown in FIG. 6A, the excitation force waveform shown in FIG. 8A, the excitation force waveform shown in FIG. 9A, the excitation force waveform shown in FIG. 10A, the excitation force waveform shown in FIG. 13A, and the excitation force waveform shown in FIG. 15B as illustrated according to the embodiment.

The inputter 22 is a user interface for the user to input a machining condition, and the setter 24 sets the machining condition input by the user. For the cutting apparatus 1 according to the embodiment, the user selects a machining shape to be formed on the machined surface. According to the embodiment, the response displacements of the oscillating system are illustrated in FIGS. 6B, 8B, 9B, 10B, 13B, and 15C, and when the user selects a machining shape using these response displacements via the inputter 22, the setter 24 sets the selected machining shape as one of the machining conditions. Further, the user inputs, into the inputter 22, an interval at which the selected machining shape is formed on the surface of the workpiece, a position at which the machining shape is formed, or a time at which the machining shape is formed, and the setter 24 sets the interval at which the machining shape is formed (machining pitch), the position at which the machining shape is formed, or the time at which the machining shape is formed (for example, an elapsed time since the start of machining) as one of the machining conditions. Note that the position at which the machining shape is formed or the time at which the machining shape is formed need not be evenly spaced, and different machining shapes may be set for each machining position or each machining time.

The controller 20 performs cutting process to form a fine shape on the workpiece 6 under the machining conditions set by the setter 24. Specifically, the controller 20 reads a voltage waveform corresponding to the selected machining shape from the storage 26, and controls the drive part 30 on the basis of the input machining pitch, plurality of machining positions, or machining time. During cutting process, the drive part 30 applies a voltage waveform to the excitation part 15 in accordance with a voltage command from the controller 20. This causes the excitation part 15 to apply excitation that contains an excitation force of components of frequencies higher than the resonance frequency and has the excitation force of the resonance frequency suppressed so as to prevent the occurrence of residual oscillations. As described above, the cutting apparatus 1 according to the embodiment can form various fine shapes on the surface of the workpiece 6 at any desired positions. Note that the controller 20 may directly or indirectly measure or estimate actual displacement of the cutting tool 11 and correct a voltage waveform to be requested when the displacement deviates from response displacement corresponding to a design value. Alternatively, the controller 20 may further have a feedback function of correcting the voltage waveforms stored in the storage 26.

As an example of indirect measurement, a method for estimating displacement containing residual oscillations from an applied voltage and flowing current may be applied to a case where a piezoelectric actuator is used. The above-described correction may be made preliminarily before machining or may be made during machining. Further, the correction may be repeated a plurality of times so as to suppress residual oscillations and obtain desired displacement with sufficiently high accuracy, and a repetitive control method often used for such a purpose may be applied.

The present disclosure has been described on the basis of the examples. It is to be understood by those skilled in the art that the examples are illustrative and that various modifications are possible for a combination of components or processes, and that such modifications are also within the scope of the present disclosure.

An outline of aspects of the present disclosure is as follows. A cutting apparatus according to one aspect of the present disclosure includes a cutting tool having a cutting edge, an excitation part structured to apply excitation to the cutting tool, and a drive part structured to apply a voltage to the excitation part to reciprocate the cutting edge of the cutting tool. The excitation part suppresses residual oscillations by applying excitation that contains an excitation force of components of frequencies higher than a resonance frequency and has an excitation force of the resonance frequency suppressed. Causing the excitation force to contain the components of frequencies higher than the resonance frequency allows high responsiveness, and suppressing the excitation force of the resonance frequency allows aperiodic response displacement to be applied to the tool cutting edge.

The excitation part may apply a first excitation, and apply a second excitation after an elapse of a time 0.5 times as long as a resonance period from timing at which the first excitation is applied to suppress residual resonance oscillations. Note that when the first excitation has a time width, it is preferable that the second excitation has the same time width. In any case, it is preferable that the second excitation be applied so as to cancel oscillations caused by the first excitation applied a time that is a half of the resonance period before the second excitation.

The cutting apparatus may further include a storage structured to store voltage waveforms corresponding to a plurality of excitation force waveforms for use in forming a plurality of machining shapes, and a setter structured to set a machining shape as a machining condition. The drive part may apply, to the excitation part, a voltage waveform corresponding to the machining shape thus set. The setter may set an interval, a position, or a time at which the machining shape is formed on a surface of a workpiece as the machining condition. The cutting apparatus may further include a feedback function of measuring displacement of the cutting tool when the voltage waveform is applied to the excitation part and correcting the voltage waveform to be applied.

Another aspect of the present disclosure is a cutting method. This method is a cutting method for applying excitation to a cutting tool having a resonance frequency to cause a cutting edge of the cutting tool to cut into a workpiece, the cutting method including suppressing residual oscillations by applying excitation that contains an excitation force of components of frequencies higher than the resonance frequency and has an excitation force of the resonance frequency suppressed.

What is claimed is:

1. A cutting apparatus comprising:
a cutting tool having a cutting edge;
an excitation part structured to apply excitation to the cutting tool; and
a drive part structured to apply a voltage to the excitation part to reciprocate the cutting edge of the cutting tool, wherein
the excitation part suppresses residual oscillations by applying excitation that contains an excitation force of components of frequencies higher than a resonance frequency when excitation is applied to the cutting tool and has an excitation force of the resonance frequency suppressed.

2. The cutting apparatus according to claim 1, wherein
the excitation part applies a first excitation, and applies a second excitation after an elapse of a time 0.5 times as long as a resonance period from timing at which the first excitation is applied to suppress residual resonance oscillations.

3. The cutting apparatus according to claim 1, further comprising:
a storage structured to store voltage waveforms corresponding to a plurality of excitation force waveforms for use in forming a plurality of machining shapes; and
a setter structured to set a machining shape as a machining condition, wherein
the drive part applies, to the excitation part, a voltage waveform corresponding to the machining shape set.

4. The cutting apparatus according to claim 3, wherein
the setter sets an interval, a position, or a time at which the machining shape is formed on a surface of a workpiece as the machining condition.

5. The cutting apparatus according to claim 3, further comprising
a feedback function of measuring or estimating displacement of the cutting tool when the voltage waveform is applied to the excitation part and correcting the voltage waveform to be applied.

6. A cutting method for applying excitation to a cutting tool having a resonance frequency to cause a cutting edge of the cutting tool to cut into a workpiece, the cutting method comprising
suppressing residual oscillations by applying excitation that contains an excitation force of components of frequencies higher than the resonance frequency when excitation is applied to the cutting tool and has an excitation force of the resonance frequency suppressed.
